(19) United States
(12) Patent Application Publication
(10) Pub. No.: US 2006/0267927 A1
(43) Pub. Date: Nov. 30, 2006

(54) User interface controller method and apparatus for a handheld electronic device

(76) Inventors: James E. Crenshaw, Palatine, IL (US); Bruce A. Augustine, Lake In The Hills, IL (US); Kevin W. Jelley, LaGrange, IL (US); Russell D. Mareachen, Carol Stream, IL (US); Michael S. Thiems, Elgin, IL (US)

Correspondence Address: MOTOROLA, INC., 1303 EAST ALGONQUIN ROAD, IL01/3RD, SCHAUMBURG, IL, 60196, US

(21) Appl. No.: 11/139,052

(22) Filed: May 27, 2005

(51) Int. Cl. G09G 5/00

(52) U.S. Cl. 345/156

(57) ABSTRACT

A user interface controller of a handheld electronic device (100) that has a camera that generates video images presents (1005) information on a display (105) of the handheld electronic device, processes (1010) the video images to track a three dimensional position of a directing object (260) that is within a field of view (225) of the camera, generates (1015) a two dimensional position of the directing object that is used to control a corresponding location in a scene on the display, and controls (1020) a function of the handheld electronic device in response to a comparison of the track of the directing device to a virtual surface (805, 810, 920, 925) that is defined relative to the handheld electronic device.

This application is related to U.S. patent application Ser. No. 10/916,384, filed on Aug. 10, 2004, entitled “User Interface Controller Method and Apparatus for a Handheld Electronic Device”

### FIELD OF THE INVENTION

This invention is generally in the area of handheld electronic devices, and more specifically in the area of human interaction with information presented on handheld electronic device displays.

### BACKGROUND

Small handheld electronic devices are becoming sufficiently sophisticated that the design of friendly interaction with them is challenging. In particular, the amount of information this is capable of being presented on the small, high density, full color displays that are used on many handheld electronic devices calls for a function similar to the mouse that is used on laptop and desktop computers to facilitate human interaction with the information on the display. One technique used to provide this interaction is a pointed object to touch the display surface to identify objects or areas showing on the display, but this is not easy to do under the variety of conditions in which small handheld devices, such as cellular telephones, are operated.

### BRIEF DESCRIPTION OF THE DRAWINGS

The present invention is illustrated by way of example and not limitation in the accompanying figures, in which like references indicate similar elements, and in which:

FIG. 1 is a functional block diagram that shows a handheld device in accordance with some embodiments of the present invention.

FIG. 2 is a perspective view that shows the handheld electronic device and includes a directing object and some virtual geometric lines, in accordance with some embodiments of the present invention.

FIG. 3 is a plan view that shows an image plane of a camera, in accordance with some embodiments of the present invention.

FIG. 4 is a cross sectional view that shows the handheld electronic device and the directing object, in accordance with some embodiments of the present invention.

FIG. 5 is a plan view that shows the image plane of the handheld electronic device that includes an object marker image, in accordance with some embodiments of the present invention.

FIG. 6 is a drawing of a directing object that may be used for both position and orientation, in accordance with some embodiments of the present invention.

FIG. 7 is a plan view of the display surface, in accordance with some embodiments of the present invention.

FIG. 8 is a perspective view that shows a handheld electronic device and includes a directing object and some virtual geometric lines, in accordance with some embodiments of the present invention.

FIG. 9 is an elevation view that shows a handheld electronic device and includes some virtual geometric lines, in accordance with some embodiments of the present invention.

FIGS. 10, 11 and 12 show a flow chart of some steps of methods that are used in the handheld device, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular human interaction technique in accordance with the embodiments of the present invention described herein, it should be observed that the embodiments reside primarily in combinations of method steps and apparatus components related to human interaction with handheld electronic devices. Accordingly, the apparatus components and method steps have been represented where appropriate by conventional symbols in the drawings, showing only those specific details that are pertinent to understanding the embodiments, so as not to obscure the disclosure with details that will be readily apparent to those of ordinary skill in the art having the benefit of the description herein.

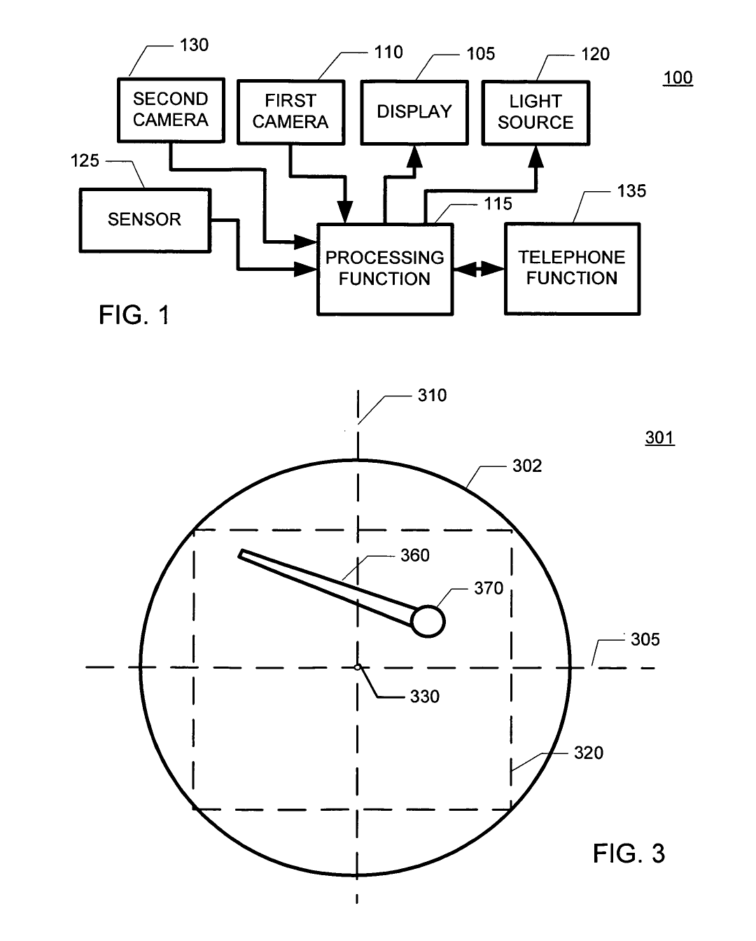

Referring to FIG. 1, a functional block diagram of a handheld electronic device 100 is shown, in accordance with some embodiments of the present invention. The handheld electronic device 100 comprises a display 105, a first camera 110, and a processing function 115 that is coupled to the display 105 and the first camera 110. The handheld electronic device 100 may further comprise a second camera 130, a light source 120, one or more sensors 125, and a telephone function 135, each of which (that are included) are also coupled to the processing function 115. The handheld electronic device 100 is uniquely comprised in accordance with the present invention as an apparatus that substantially improves human interaction with the handheld electronic device 100 in comparison to conventional devices, and a method for effecting such improvements that involves the handheld electronic device 100 is also described herein.

The handheld electronic device 100 is preferably designed to be able to be held in one hand while being used normally. Accordingly, the display 105 is typically small in comparison to displays of such electronic devices as laptop computers, desktop computers, and televisions designed for tabletop, wall, or self standing mounting. The handheld electronic device 100 may be a cellular telephone, in which case it will include the telephone function 135. In particular, when the handheld electronic device 100 is a cellular telephone, then in many cases, the display 105 will be on the order of 2 by 2 centimeters. Most electronic devices 100 for which the present invention is capable of providing meaningful benefits will have a display viewing area that is less than 100 square centimeters. The viewing surface of the display 105 may be flat or near flat, but alternative configurations could be used with the present invention. The technology of the display 105 may be any available technology compatible with handheld electronic devices, which for conventional displays includes, but is not limited to, liquid crystal, electroluminescent, light emitting diodes, and organic light emitting devices. The display 100 may include electronic circuits beyond the driving circuits that for practical purposes must be collocated with a display panel; for example, circuits may be included that can receive a video signal from the processing function 115 and convert the video signal to electronic signals needed for the display driving circuits. Such circuits may, for example, include a microprocessor, associated program instructions, and related processing circuits, or may be an application specific circuit.

The cellular telephone function 135 may provide one or more cellular telephone services of any available type. Some conventional technologies are time division multiple access (TDMA), code division multiple access (CDMA), or analog, implemented according to standards such as GSM, CDMA 2000, GPRS, etc. The telephone function 135 includes the necessary radio transmitter(s) and receiver(s), as well as processing to operate the radio transmitter(s) and receiver(s), encode and decode speech as needed, a microphone, and may include a keypad and keypad sensing functions needed for a telephone. The telephone function 135 thus includes, in most examples, processing circuits that may include a microprocessor, associated program instructions, and related circuits.

The handheld electronic device 100 may be powered by one or more batteries, and may have associated power conversion and regulation functions. However, the handheld electronic device 100 could alternatively be mains powered and still reap the benefits of the present invention.

The first camera 110 is similar to cameras that are currently available in cellular telephones. It may differ somewhat in the characteristics of the lens optics that are provided, because the present invention may not benefit greatly from a depth of field range that is greater than approximately 10 centimeters (for example, from 5 centimeters to 15 centimeters) in some embodiments that may be classified as two dimensional. In some embodiments that may include those classified as two dimensional, as well as some embodiments classified as three dimensional, the first camera 110 may benefit from a depth of field that is very short—that is, near zero centimeters, and may not provide substantially improved benefits by being more than approximately 50 centimeters. In one example, the present invention may provide substantial benefits with a depth of field that has a range from about 5 centimeters to about 25 centimeters. These values are preferably achieved under the ambient light conditions that are normal for the handheld device, which may include near total darkness, bright sunlight, and ambient light conditions in between those. Means of achieved the desired depth of field are provided in some embodiments of the present invention, as described in more detail below. A monochrome camera may be very adequate for some embodiments of the present invention, while a color camera may be desirable in others.

The processing function 115 may comprise a microprocessor, associated program instructions stored in a suitable memory, and associated circuits such as memory management and input/output circuits. It may be possible that the processing function 115 circuits are in two or more integrated circuits, or all in one integrated circuit, or in one integrated circuit along with other functions of the handheld electronic device 100.

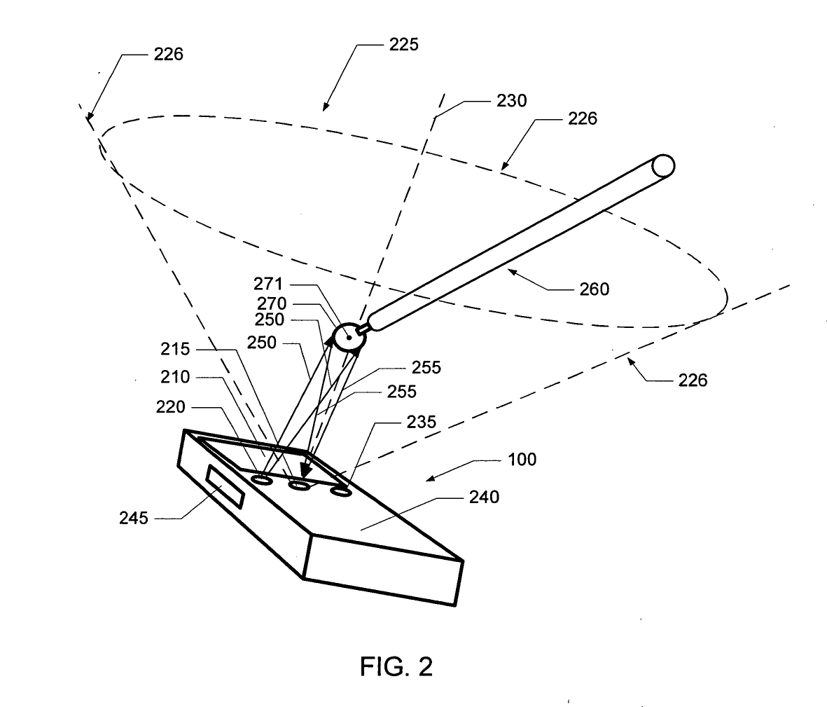

Referring to FIG. 2, a perspective view of the handheld electronic device 100 is shown that includes a directing object 260 and some virtual geometric lines, in accordance with some embodiments of the present invention. Shown in this view of the handheld electronic device 100 are a viewing surface 210 of the display, a camera aperture 215, a light source aperture 220, a sensor aperture 235, a sensor that is a switch 245, and a keypad area 240. The first camera 110 has a field of view 225 that in this example is cone shaped, as indicated by the dotted lines 226, having an axis 230 of the field of view. The axis 230 of the field of view is essentially perpendicular b the surface 210 of the display. (The display viewing surface is assumed to be essentially parallel to the surface of the handheld electronic device 100.) For typical displays 105, which are planar in their construction, the axis may be said to be oriented essentially perpendicular b the display 105. The camera aperture 215 may include a camera lens, and may also be referred to as camera lens 215.

The directing object 260 may be one of a variety of objects, one of which may be described as a wand, which in the particular embodiment illustrated in FIG. 2 includes a sphere 270 mounted on one end of a handle. Other embodiments could be a person's finger, a fingernail, or a thimble-like device carried on a fingertip. The directing object 260 may be held by a hand (not shown in FIG. 2). When the directing object is a wand with a sphere 270, the sphere 270 has a surface that may produce an image 370 (FIG. 3) on an image plane 301 (FIG. 3) of the first camera 110, via light that projects 255 from the surface of the sphere 270. The surface of the sphere is called herein the directing object marker, and in other embodiments there may be a plurality of directing object markers. When the embodiment involves a finger, there may be only one directing object marker, such as a fingernail or a thimble-like device. The light projecting 255 onto the image plane 301 may be, for example, ambient light that is reflected from the surface of the sphere 270, light that is emitted from the light source 120 and reflected from the surface of the sphere 270, or light that is generated within the sphere 270 which is transmitted through a transparent or translucent surface of the sphere, or light that is generated at the surface of the sphere 270. An image 360 of the surface of the other part (a handle) of the directing object 260 (which is not a directing object marker in this example) may also be projected on the image plane 301 by reflected light. In some embodiments, the object marker may cover the entire directing object.

Referring to FIG. 3, a plan view is shown of an image plane 301 of the first camera 110, in accordance with some embodiments of the present invention. The image plane 301 may be the active surface of an imaging device, for example a scanned matrix of photocells, used to capture the video images. In the example shown in FIG. 3, the active surface of the imaging device has a periphery 302, which corresponds approximately to the limits of the field of view of the first camera 110. The image 360 of the directing object 260 and the image 370 of the sphere 270 produced on the image plane 301 is called the image of the object marker (or object marker image). The directing object 260 may be implemented in alternative embodiments that generate alternative object marker images, as will be further detailed below. In alternative embodiments of the present invention more than one object marker may be provided on the directing object. In many of the embodiments, the directing object is designed to be comfortably held and moved over the handheld electronic device 100 by one hand while the handheld electronic device 100 is held in the other hand. The first camera 110 generates a succession of video images by techniques that may include those that are well known to one of ordinary skill in the art. The object marker image 370 may appear at different positions and orientations within successive video images, in response to movement of the directing object 260 relative to the handheld electronic device 100. It will be appreciated that in general, the object marker image is not simply a scaled version of a two dimensional view of the directing object (in which the plane of the two dimensional view is perpendicular b the axis of the field of view), because the object marker image is cast onto the image plane through a conventional lens which produces an image that is distorted with reference to a scaled version of a two dimensional view of the directing object. Thus, the object marker image in this example is not a circle, but more like an ellipse.

The processing function 115 uniquely includes a first function that performs object recognition of the object marker image 370 using techniques that may include well known conventional techniques, such as edge recognition, and a second function that determines at least a two dimensional position of a reference point 271 (FIG. 2) of the directing object 260, using techniques that may include well known conventional techniques. When the directing object is an object such as a finger, a fingernail, or a thimble-like object, the reference point 271 may be a point at a tip of the finger, fingernail, or thimble-like object. In one embodiment, the two dimensional position of the reference point 271 is defined as the position of the projection of the reference point 271 on the image plane 301, using a co-ordinate system that is a set of orthogonal rectangular axes 305, 310 having an origin in the image plane at the point where the image plane is intersected by the axis 230 of the field of view 225. Although this does not identify the two dimensional position of the reference point 271 itself within a three dimensional rectangular coordinate system having the same origin, defining the position of the projection of the object marker(s) in this manner may be suitable for many uses of the present invention. In the example illustrated, the first function recognizes the object marker image 370 as a circle somewhat modified by the projection, and the second function determines the two dimensional position of the center of the object marker image 370 within the orthogonal coordinate system 305, 310 of the image plane 301. In some embodiments, the object marker image may be sufficiently close to a circle that it is recognized using equations for a circle. In other embodiments, the first function of the processing function 115 identifies an image of an object marker, such as a fingertip, fingernail, or thimble-like device, that is more complicated than projected sphere, and the second function of the processing function 115 determines a three dimensional position and an orientation of a directing object. A third function of the processing function 115 maintains a history of the position (or orientation, when determined by the second function, or both) of the directing object 260 obtained from at least some of the successive video images generated by the first camera 110. The first, second, and third functions of the processing function 115 are encompassed herein by the term “generating a track of a directing object that is within a field of view of the first camera”, and the “track of the directing object” constitutes in general a recent history of the three dimensional position of the directing object, and may also include an orientation of the directing object, over a time period that may be many seconds, but may in some circumstances constitute a subset of the more general definition of “the track of a directing object”, such as simply a current position of the directing object.

As will be described in more detail below, the processing function may perform a further function of modifying a scene that is displayed on the display 105 in response to the track of the directing object 260 in the coordinate system used for tracking. Related to this aspect is a mapping of the directing object's track from the coordinate system used for the tracking of the directing object to the display 105, which has a periphery that is depicted in FIG. 3 as square 320. It will be appreciated that the mapping of the directing objects' track to the display 105 may be more complicated than a simple relationship that might be inferred in FIG. 3, wherein if the display is square, then the relationship of the coordinates for the directing objects track as defined in a coordinate system related to the first camera 110 and display might be a single scaling value. It is easy to see that if the display is rectangular, then the display could be mapped as the square shown, by using different scaling values in the x and y directions. Other mappings could also be used. For example a rectangular display could be mapped using a common scaling factor in the x and y directions; in which case the distances moved by the directing object 260 that correspond to the x and y axes of the display would be different.

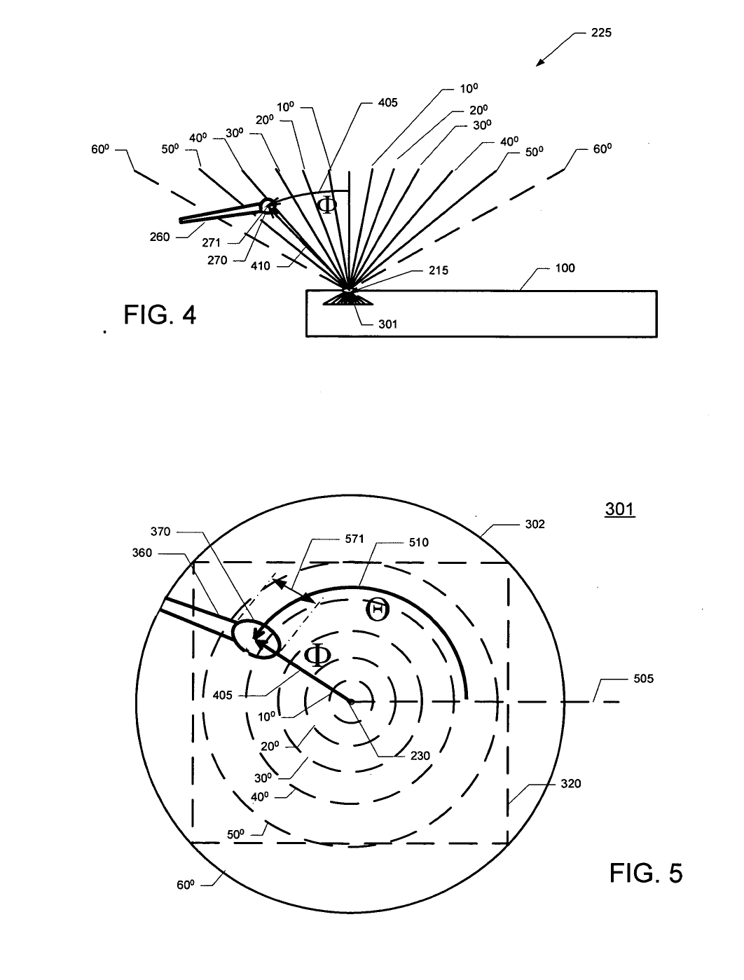

Referring to FIG. 4, a cross sectional view of the handheld electronic device 100 and the directing object 260 is shown, in accordance with some embodiments of the present invention. Referring to FIG. 5, a plan view of the image plane 301 of the handheld electronic device 100 is shown that includes the object marker image 370 produced by the surface of the sphere when the directing object 260 is in the position relative to the handheld electronic device 100 as illustrated in FIG. 4. The directing object 260 is not necessarily in the same position relative to the handheld electronic device 100 as shown in FIG. 2 or 3. Also illustrated in FIGS. 4 and 5 is a three dimensional coordinate system having an origin at a center of projection of a lens in the first camera aperture 215. The position of the directing object 260, which is the position of the center of the sphere 270, is defined in three dimensions in this example using three dimensional co-ordinates, which are identified as Phi (φ) 405, Theta (θ) 510, and R 410. Theta is an angle of rotation in the image plane 301 about the axis 230 of the field of view 225 with reference to a reference line 505 in the image plane 301. Phi is an angle of inclination from the axis 230 of the field of view 225, and R is the distance from the origin to the position of the directing object 260 (reference point 271). In FIG. 5, the projection of the loci of all positions having a constant value of φ (e.g., 30°) is a circle. It will be appreciated that the size of the object marker image 370, increases as the distance, R, to the sphere 270 is reduced, but also that the image of the sphere 270 is changed from a circle when φ is zero degrees to an elliptical shape that becomes more elongated as φ increases. R can be determined from a measurement of a dimension of the elliptical image of the sphere 270, such as the major axis 571 of the ellipse, and from the angle φ. The angle φ can be determined by the distance on the image plane 301 of the center of the major axis 571 from the intersection of the axis 230 with the image plane 301. Thus, a three dimensional position of the directing object 260 is determined. However, it will be further appreciated from the descriptions given with reference to FIGS. 3-5 that the orientation of the directing object 260 may not be determined by the measurements described, since the object marker of these examples is a sphere. When a directing object more complicated than a sphere is used, such as a fingernail or a thimble-like object, the same principles apply but more complicated formulas have to be used. For example, the principle that the distance of the directing object from the first camera aperture is related to the size of the object marker image is still accurate, but determining the size of the object marker image may be more difficult, and may involve determining an orientation of the directing object.

A determination of the position and orientation of a directing object in a three dimensional coordinate system by using a camera image can be made from 6 uniquely identifiable points positioned on the directing object. However, it will also be appreciated that simpler methods can often provide desired position and orientation information. For example, it may be quite satisfactory to determine only an orientation of the handle of the directing object 260 described with reference to FIGS. 3-5 (i.e., not resolving an amount of roll around the axis of the handle). Also, some theoretical ambiguity may be acceptable, such as assuming in the above example that the handle is always pointing away from the camera. For some uses, only a three dimensional position and no orientation may be needed, while in others, only a two dimensional position without orientation may be needed. In accordance with embodiments of the present invention described more fully herein, a three dimensional position may be sufficient. In some of these embodiments, the distance of the reference point from the image plane is used in a manner quite independent from the manner in which the location of the reference point in the other two dimensions is used.

There are a variety of techniques that may be used to assist the identification of the directing object by the processing function 115. Generally speaking, an object of such means is to improve a brightness contrast ratio and edge sharpness between of the images of certain points or areas of the directing object 260 with reference to the images that surround those points or areas, and make the determination of defined point locations computationally simple. In the case of the wand example described above, the use of a sphere projects a circular, or nearly circular, image essentially regardless of the orientation of the wand (as long as the thickness of the handle is small in comparison to the diameter of the sphere 270), with a defined point location at the center of the sphere. The sphere 270 may be coated with a highly diffuse reflective white coating, to provide a high brightness contrast ratio when operated in a variety of ambient conditions. For operation under perhaps more ambient conditions, the sphere 270 may be coated with a retro-reflective coating and the handheld electronic device 100 may be equipped with a light source 120 having an aperture 220 located close to the first camera aperture 215. The sphere 270 may be a light source. In some embodiments, the image processing function may be responsive to only one band of light for the object marker image (e.g., blue), which may be produced by a light source in the object marker(s) or may selectively reflected by the object marker(s). For directing objects other than the wand 260, similar enhancements may be of help. For example, a thimble-like object may have a reflective white coating, or a fingernail that has fingernail polish of a particular color may improve detection reliability, particularly in poor lighting conditions.

The use of directing object markers that are small in size in relation to the field of view at normal distances from the first camera 110 may be particularly advantageous when there are multiple directing object markers. The directing object may take any shape that is compatible with use within a short range (as described above) of the handheld electronic device 100 and appropriate for the amount of tracking information that is needed. For example, the wand described herein above may be most suitable for two dimensional and three dimensional position information without orientation information. Directing object markers added to the handle of the wand (e.g., a couple of retro-reflective bands) may allow for limited orientation determinations that are quite satisfactory in many situations. In a situation where full orientation and three dimensional positions are needed, the directing object may need to have one or more directing object markers sufficiently spaced so that six are uniquely identifiable in all orientations d the directing object during normal use. In general, the parameters that the image processing function uses to identify the images of the directing object markers and track the directing object include those known for object detection, and may include such image detection parameters as edge detection, contrast detection, shape detection, etc., each of which may have threshold and gain settings that are used to enhance the object detection. Once the images of the directing object markers have been identified, a first set of formulas may be used to determine the position of the directing object (i.e., the position of a defined point that is fixed with reference to the body of the directing object), and a second set of formulas may be used to determine the orientation. More typically, the first and second formulas are formulas that convert such intermediate values as slopes and ends of edges to a marker position and orientation in a chosen coordinate system.

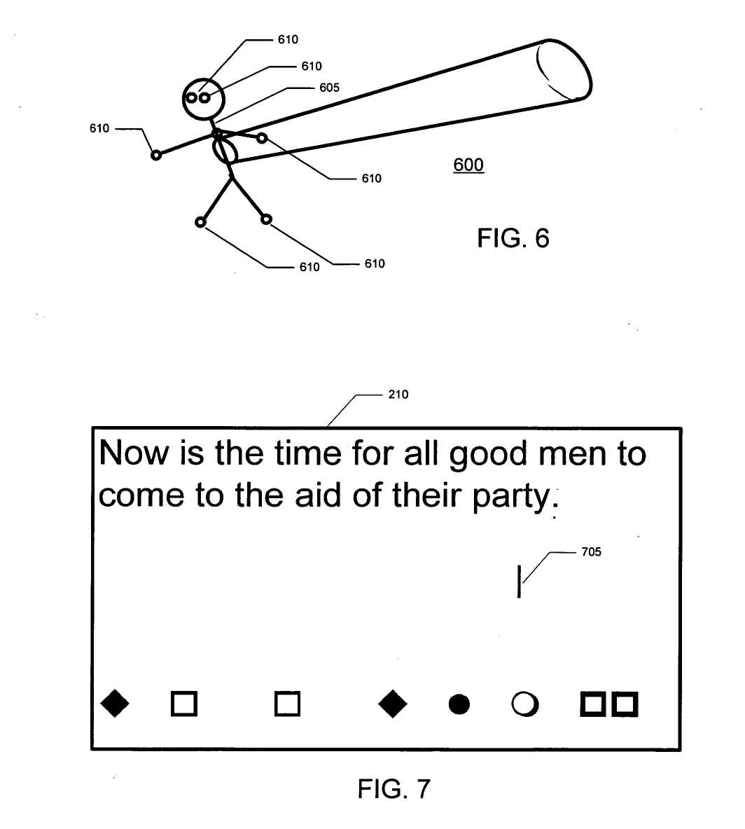

For the purpose of keeping complexity of the processing function 115 down, it is desirable to use reflective directing object markers. This provides the advantage of making the directing object markers appear brighter than other objects in the image. If this relative brightness can be increased sufficiently, then the shutter speed can be increased to the point where almost no other objects are detected by the camera. When the number of undesired objects in the image is reduced, a much simpler algorithm may be used to identify the directing object markers within the image. Such a reduction in complexity translates into reduced power consumption, because fewer results must be calculated. Such a reduction in complexity also reduces processing function cost since memory requirements may be reduced, and fewer special processing accelerators, or a slower, smaller processor core can be selected. In particular, the reflective material may be retro-reflective, which is highly efficient at reflecting light directly back toward the light source, rather than the more familiar specular reflector, in which light rays incident at angle α are reflected at angle 90-α (for instance in a mirror), or Lambertian reflectors, which reflect light in a uniform distribution over all angles. When retro-reflectors are used, it is necessary to include a light source 120 such as an LED very close to the camera lens 215 so that the lens 215 is in the cone of light reflected back toward the illuminant by the retro-reflective directing object markers. One embodiment of a directing object that may provide determination of three dimensional positions and most normal orientations is shown in FIG. 6, which is a drawing of a wand 600 that has a stick FIG. 605 on one end. The stick FIG. 605 provides a natural indication to the user of the orientation of the directing object, and includes a plurality of retroreflectors 610. (Alternatively, the retroreflectors 610 could be replaced by light emitting components, which may use different colors to simplify identification of the directing object markers, but which would add complexity to the wand compared to retroreflectors, and which may not work as well in all ambient lighting conditions).

In other embodiments, the axis of the field of view may be directed away from being perpendicular to the display. For example, the axis of the field of view may be directed so that it is typically to the right of perpendicular when the handheld electronic equipment is held in a user's left hand. This may improve edge detection and contrast ratio of image markers that may otherwise have a user's face in the background, due to a longer range to objects in the background of the directing object other than the user's face. This biasing of the axis of field of view away from the user's face may require a left hand version and a right hand version of the handheld electronic device, so an alternative is to provide a first camera 110 that can be manually shifted to improve the probability of accurate image detection under a variety of circumstances.

Referring now to FIG. 7, a plan view of the display surface 210 is shown, in accordance with some embodiments of the present invention. This view shows a scene that comprises characters and icons. The term scene is used herein to mean one set of information shown on the display amongst many that may vary over time. E.g., a text screen such as that shown may change by having a character added, changed or deleted, or by having an icon change to another icon, for example. For other uses, the scene may be one frame of a video image that is being presented on the display 105. As described above, the track of the directing object may be used by the processing function to modify a scene on the display 105. Such modifications include, but are not limited to moving a cursor object within one or more successive scenes on the display, selecting one or more scene objects within one or more successive scenes on the display, and adjusting a viewing perspective of successive scenes on the display. The cursor object 705 may be appear similar to a text insertion marker as shown in FIG. 7, but may alternatively may any icon, including, but not limited to, such familiar cursor icons as a hourglass or plus sign, or an arrow, which may or may not be blinking or have another type of changing appearance. The cursor object 705 may be moved in response to the position of the directing object in two dimensions, and may be used in conjunction with other commands to perform familiar cursor functions such as selecting one or more of the characters or icons. The commands may be any command for impacting the motion, use, or appearance of the cursor object, including, but not limited to, those associated with mouse buttons, such as left click, right click, etc. The commands may alternatively be commands that impact functions not related to the cursor. Examples of such functions include, but are not limited to, an audio volume level change and a channel selection. The commands may be entered using any input sensor for a handheld device, such as one or more push or slide switches, rotary dials, keypad switches, a microphone coupled with a command recognition function, and a touch sensor in the display surface 210 or elsewhere. The command sensing technique may be a detection of a unique track of the directing object 260 in the video image by the image processing function that is reserved for a command in a particular application, such as a very fast movement of the directing object away from the display 105. In accordance with some embodiments of the present invention, a detection of subsequent positions of the directing object that differ in a particular manner in one dimension that best defines a distance of the directing object from the handheld electronic device is used to initiate a command or one of a few commands, as more fully described below. The command sensing technique may involve the detection of a unique pattern of directing object markers. For example an object marker that is normally not energized may emit light in response to an action on the part of the user, such as pressing a button on the directing object. An alternative or additional technique is to change the color or brightness of an object marker in response to a user's hand action.

A command may initiate a drawing function that draws a scene object in response to motions of the cursor that are in response to movement of the directing object. Such drawing may of any type, such as a creation of a new picture, or in the form of overlaying freeform lines on a scene obtained from another source. As one example, a user of another computing device may send a picture to the handheld device 100 and the user of the handheld device may identify a first scene object (e.g., a picture of a person in a group of people) by invoking a draw command and drawing a second scene object on top of the scene by circling the first scene object using the directing object. The user of the handheld device 100 may then return the marked up picture to the computing device (e.g., by cellular messaging) for presentation to the user of the computing device.

While examples of two-dimensional position tracking have been described above, two dimensional position and orientation tracking may also by useful, as for a simple game of billiards that is presented only as a plan view of the table and queue sticks. When overlaid by commands that are independently generated by movement of the directing object 260 in the dimension that is essentially orthogonal to the two dimensions that are used for the two dimensional position, which is a dimension that essentially identifies a distance from the handheld electronic device 100, such a game may be played without having to use any keys on the handheld electronic device.

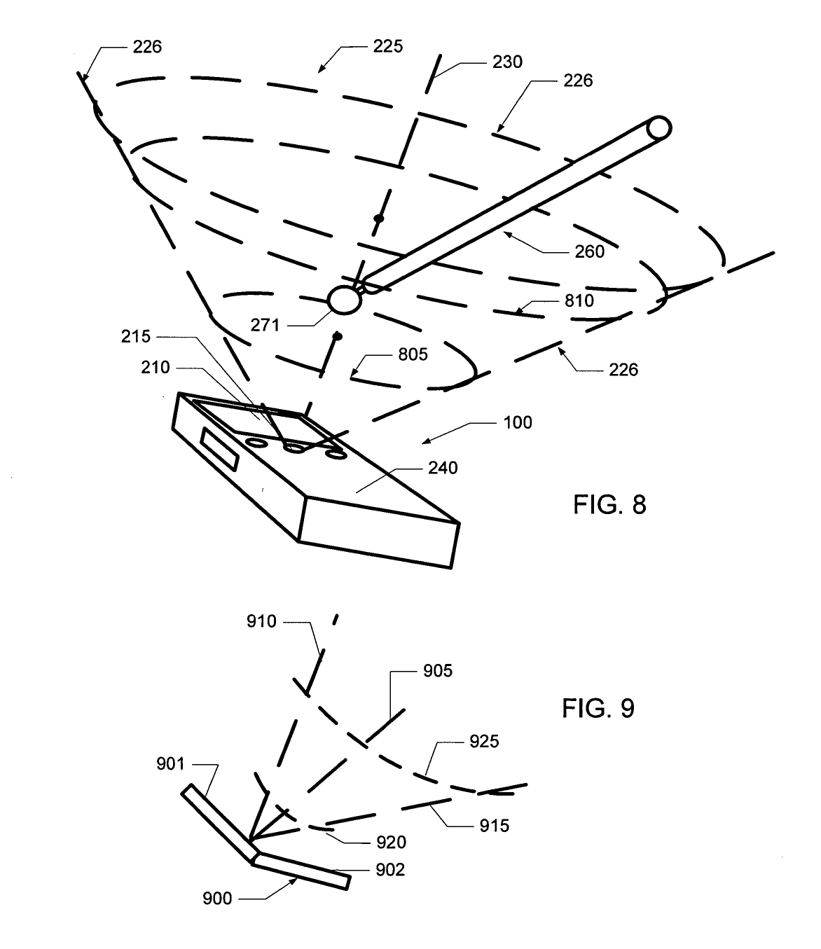

Referring now to FIG. 8, a perspective view of the handheld electronic device 100 is shown that is similar to the one shown in FIG. 2, in accordance with some embodiments of the present invention. Virtual surfaces 805 and 810, which in this example are two virtual planar surfaces, are defined with reference to the handheld electronic device for the processing function 115 to use to generate command events based essentially on the distance of the directing object 260 from the handheld device 100. In some embodiments, only one virtual planar surface may be used.

Referring to FIG. 9, a cross sectional view of a handheld electronic device 900 is shown, in accordance with some embodiments of the present invention. The handheld electronic device 900 has a camera with a field of view axis 905 and field of view periphery shown by lines 910, 915 and otherwise operates the same as the handheld electronic device 100. Two virtual surfaces 920, 925 are shown that are not planar, but have the same function as those shown in FIG. 8; namely, they are defined with reference to the handheld electronic device for use by the processing function 115 to generate command events based essentially on the distance of the directing object 260 from the handheld device 100. In this instance, a user's perception of a particular distance from the handheld electronic device is better matched by using the non-planar virtual surfaces 920, 925 because the handheld electronic device 900, when opened for use by a directing object, presents two planar surfaces 901, 902 to the user instead of the one planar surface as illustrated in FIG. 2. Since the two planar surfaces 901, 902 of the electronic device 900 are at an angle less than 180 degrees, the user's perception of uniform distance from the handheld unit may be better approximated by curved virtual surfaces 920, 925 rather than a plane surface. In general, embodiments of the present invention may use any three dimensional surface or surfaces that allow a user to acceptably interact with the handheld electronic device 100.

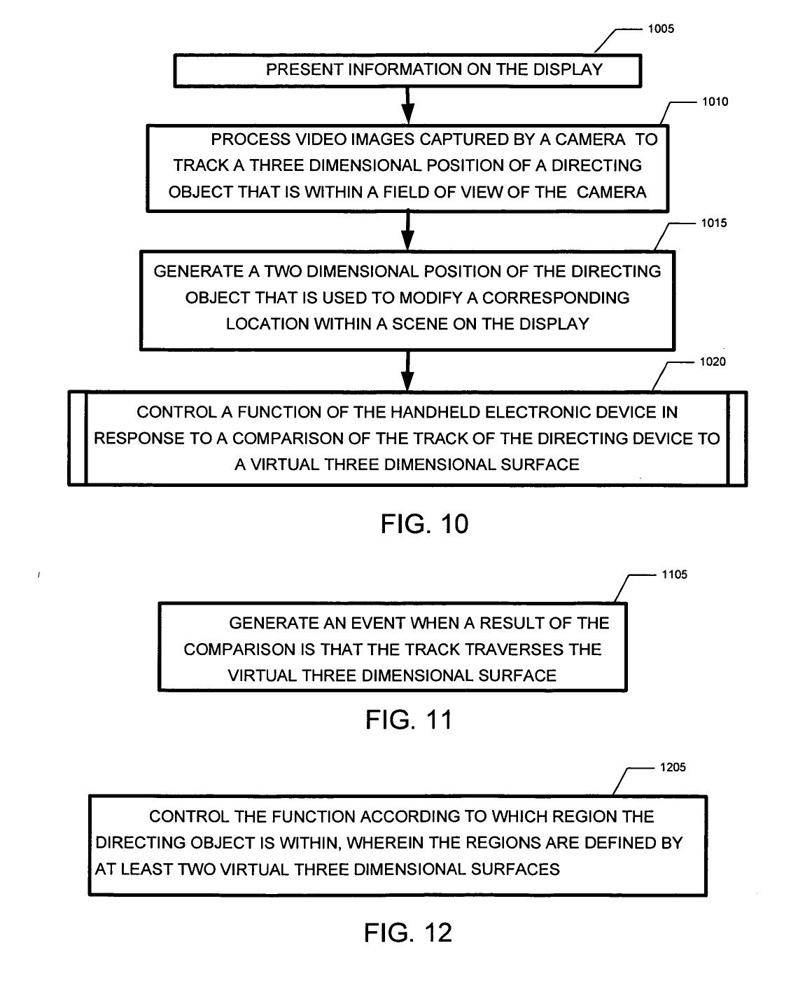

Referring to FIG. 10, steps of a unique method used in the handheld devices 100, 900 are shown, in accordance with some embodiments of the present invention. At step 1005, information is presented on the display 105. Video images captured by a camera are processed at step 1010 to track a three dimensional position of a directing object, such as directing object 260 (FIG. 2), that is within a field of view of the camera, and may also track an orientation of the directing object. At step 1015, a two dimensional position of the directing object is generated, wherein the two dimensional position is used to modify a corresponding location in a scene on a display, such as the display 105 (FIG. 1). To “control a corresponding location in a scene on the display” means that some visual aspect of the display may be affected, such as a cursor or other icon being positioned in response to the track of the directing object in the two dimensions that are essentially in an image plane, such as the image plane 301 (FIG. 3). Furthermore, to “control a corresponding location in a scene on the display” need not be an exact one-to-one correspondence, In one example, when a location on the display has been reached by a cursor and the two dimensional position changes by less than some threshold (while the directing object is moved substantially in the direction of the third dimension), the method may freeze the location within the scene. At step 1020, a function of the handheld electronic device 100, 900 is controlled in response to a comparison of a current location of the directing device and a virtual surface that is defined relative to the handheld electronic device.

Referring to FIG. 11, a flow chart shows details of step 1020 for some embodiments of the present invention. In these embodiments only one virtual surface is defined, such as either surface 805 of FIG. 8 or surface 920 of FIG. 9, is defined with reference to the handheld electronic device 100, 900. A processing function of the handheld device generates an event at step 1105 when the position of a directing object tracked by the processing function traverses the virtual surface, i.e, crosses from one side of the surface to the other at a point on the surface. In some of these embodiments, the processing function also generates a direction of the traverse of the virtual surface. By using events generated in one of these forms (with or without the directional indication) the processing function can generate the equivalent of essentially any conventional single mouse button event. The processing function may use the two dimensional position of the directing device to control a corresponding location on the display, in an essentially simultaneous manner, regardless of which side of the (single) virtual surface the directing object is on.

Referring to FIG. 12, a flow chart shows details of step 1020 for some embodiments of the present invention. In these embodiments at least two surfaces are defined, such as surfaces 805, 810 of FIG. 8 and surfaces 920, 925 of FIG. 9. Using the example of FIG. 9, three regions are defined by the two surfaces 920, 925. A processing function of the handheld device controls a function by generating repetitive first events at step 1205 when the position of a directing object tracked by the processing function is within a region that encompasses those locations that are farther from the handheld electronic device 100, 900 than virtual surface 925. The processing function generates repetitive second events at step 1205 when the position of the directing object tracked is within a region that encompasses those locations that are nearer to the handheld electronic device 100, 900 than virtual surface 920. When the directing object is between virtual surfaces 920, 925, the processing function may use only the two dimensional position of the directing device to control a corresponding location on the display, but when the directing device is in one of the other two regions, the processing function may use the two dimensional position of the directing device to control a corresponding location on the display while generating the repeating event essentially simultaneously. In some examples of these embodiments, the first event may be used to incrementally decrease an audio volume control or lower a scroll control, while the second event may be used, respectively, to incrementally increase the audio volume control or raise a scroll control.

A more general description of step 1205 may be that, for at least one of a plurality of regions (e.g., two of three regions in the last example), the function is controlled according to which of the at least one of the plurality of regions the directing object is within, and wherein the plurality of regions (three in the last example) are defined by at least two virtual surfaces that are defined with reference to the handheld electronic device. Each region has as a boundary comprising at least one of the plurality of virtual surfaces.

In an extension to the embodiments in which at least one of a plurality of regions are used to control a function, sectors may be defined in the region(s) that control the function in order to multiply the number of modes or states of control that are defined within a region. This approach may be used when only one virtual surface is defined with reference to the handheld electronic device, resulting in only one region that is used for controlling a function, within a total of two regions that are defined by the virtual surface. Of course, two or more such regions that control a function could be defined and used by defining more than one virtual surface, and sectors could be defined within one or more of the regions that control the function. In such cases, “the function” may comprise a plurality of sub-functions, each of which could be conveniently associated with a set of sectors, or a region. In some contexts, the sub-functions may be described as separate functions.

In the embodiments in which sectors are defined in one or more regions, the sectors may be mutually exclusive portions of the region. In the embodiments in which sectors are defined in one or more regions, the processing function uses the sector to control a mode or state of the function, and does not simultaneously use the two dimensional position of the directing object for controlling a corresponding location of the display. In those embodiments in which there are more than one virtual surface, it will be appreciated that the surfaces are defined so as not to intersect within the field of view of the camera. In some embodiments, region or sector boundaries may vary over time. For example, the virtual surface may be altered in response to a change of the orientation of parts of the handheld device with reference to each other, or a change in environmental conditions.

In an example in which sectors are used, the region comprising locations farther from the handheld electronic device 100 (FIG. 8) than virtual surface 810 (FIG. 8) may be broken into four quadrants, which relative to a user may by described as an upper right quadrant (sector I), a lower right quadrant (sector II), a lower left quadrant (sector II) and an upper left quadrant (sector IV). Furthermore, the region comprising locations nearer to the handheld electronic device 800 (FIG. 8) than virtual surface 805 (FIG. 8) may be broken into two halves, which relative to a user, may by described as a left half (sector V), a lower right quadrant (sector VI). Sector I and II may then be used to control a volume setting sub-function, sectors II and IV a channel setting sub-function, and sectors V and VI a scroll sub-function of a function that controls settings of the handheld device.

A mode of the handheld electronic device in which a function is controlled using one or more virtual surfaces need not be a permanent mode of the handheld electronic device. For example, physical controls on the handheld electronic device, or, for another example, a sector of a region, may change an operating mode of the handheld electronic device to a different mode. Different operating modes may change the number of virtual surfaces (e.g., from zero to one or two), the number of sectors, and may correspondingly invoke differing functions that are controlled by the regions that serve as controls.

It will be appreciated that a scene presented on the display 105 may be one that has been stored in, or generated from memory, or received by the handheld device 100. In some embodiments, the handheld device 100 may have a second built in camera, as is well known today, for capturing still or video images, or the first camera may be used for capturing a still or video image that is presented as a scene on the display for modification using the directing object.

It will be appreciated the processing function 115 and portions of one or more of the other functions of the handheld electronic device, including functions 105, 110, 120, 125, 130, 135 may comprise one or more conventional processors and corresponding unique stored program instructions that control the one or more processors to implement some or all of the functions described herein; as such, portions of the processing function 115 and portions of the other functions 105, 110, 120, 125, 130, 135 may be interpreted as steps of a method to perform the functions. Alternatively, these functions 115 and portions of functions 105, 110, 120, 125, 130, 135 could be implemented by a state machine that has no stored program instructions, in which each function or some combinations of portions of certain of the functions 115, 105, 110, 120, 125, 130, 135 are implemented as custom logic. Of course, a combination of the two approaches could be used. Thus, both a method and apparatus for a handheld electronic device has been described herein.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

A “set” as used herein, means a nonempty set (i.e., for the sets defined herein, each comprises at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A user interface controller of a handheld electronic device, comprising:
a display,
a camera that generates video images; and
a processing function coupled to the display and the camera, that presents information on the display,
processes the video images to generate a three dimensional track of a position of a directing object that is within a field of view of the camera,
generates a two dimensional position of the directing object that is used to control a corresponding location within a scene on the display, and
controls a function of the handheld electronic device in response to a comparison of the track of the directing object to a virtual surface that is defined relative to the handheld electronic device.

2. The user interface controller according to claim 1, further comprising generating an event when a result of the comparison is that the track traverses the virtual surface, while generating the two dimensional position essentially simultaneously.

3. The user interface controller according to claim 2, wherein a direction of the traverse is associated with the event.

4. The user interface controller according to claim 2, wherein the event is used as a virtual mouse button event.

5. The user interface controller of a handheld electronic device according to claim 1, wherein the display has a viewing area that is less than 100 square centimeters.

6. The user interface controller of a handheld electronic device according to claim 1, wherein the camera has a depth of field range of at least 10 centimeters under lighting conditions expected for normal use.

7. The user interface controller of a handheld electronic device according to claim 1, wherein an axis of the field of view of the camera is oriented in a direction essentially perpendicular to the display.

8. The user interface controller of a handheld electronic device according to claim 1, wherein an axis of the field of view is oriented in a direction biased away from an expected direction of an operator's face.

9. The user interface controller of a handheld electronic device according to claim 1, wherein an axis of the field of view of the camera can be moved by an operator of the handheld electronic device.

10. The user interface controller of a handheld electronic device according to claim 1, wherein the processing function that processes the video images to generate the track of the position of the directing object is responsive to images of one or more directing object markers that have one or more of the group of characteristics comprising:
each object marker image is a projection of a defined shape that includes at least one defined point location,
each object marker image is small in size in relation to the field of view,
each object marker image has a high brightness contrast ratio compared to the immediate surroundings, and
each object marker image primarily comprises light in a particular light band.

11. The user interface controller according to claim 1, wherein, for at least one of a plurality of regions, the function is controlled according to which of the at least one of the plurality of regions the directing object is within, and wherein the plurality of regions are defined by a plurality of virtual surfaces that are defined with reference to the handheld electronic device.

12. The user interface controller according to claim 11, wherein when the directing object is within one of the at least one of the plurality of regions, the two dimensional position of the directing object is used for identifying one of a plurality of mutually exclusive sectors of the one of the at least one of the plurality of regions instead of being used for controlling a corresponding location within a scene on the display, and wherein the function is controlled according to a sector and region the directing object is within, for at least one of the plurality of regions.

13. The user interface controller according to claim 11, wherein the plurality of virtual surfaces is two virtual surfaces that are located at two distances from the plane of the display, and wherein the two virtual surfaces define a near region, an intermediate region, and a far region.

14. The user interface controller according to claim 13, wherein the near and far regions are used to control an increase and decrease in value of a function of the handheld electronic device.

15. The user interface controller according to claim 14, wherein the function includes one more of zoom control, scroll control, audio volume control, and channel selection.

16. A user interface method used in a handheld electronic device that has a camera that generates video images and has a display, comprising:
presenting information on the display;
processing the video images to generate a three dimensional track of a position of a directing object that is within a field of view of the camera;
generating a two dimensional position of the directing object that is used to control a corresponding location in a scene on the display; and
controlling a function of the handheld electronic device in response to a comparison of the track of the directing device to a virtual surface that is defined relative to the handheld electronic device.
